(19) United States
(12) Patent Application Publication
(10) Pub. No.: US 2024/0144719 A1
(43) Pub. Date: May 2, 2024

(54) SYSTEMS AND METHODS FOR MULTI-TIERED GENERATION OF A FACE CHART

(71) Applicant: Perfect Mobile Corp., New Taipei City (TW)

(72) Inventors: Guo-Wei LI, New Taipei City (TW); Kuo-Sheng LIN, New Taipei City (TW)

(21) Appl. No.: 18/468,796

(22) Filed: Sep. 18, 2023

Related U.S. Application Data
(60) Provisional application No. 63/381,204, filed on Oct. 27, 2022.

(51) Int. Cl. G06V 40/16; G06V 10/44; G06V 10/82

(52) U.S. Cl. CPC G06V 40/171; G06V 10/454; G06V 10/82

(57) ABSTRACT

A computing device obtains an image depicting an image of a user's face. The computing device identifies one or more regions in the image depicting skin of the user and generates a skin mask. A skin tone of the user's face is predicted and the skin mask is populated according to the predicted skin tone. The computing device defines feature points corresponding to facial features on the user's face and extracts pre-defined facial patterns matching facial features depicted in the image. The extracted pre-defined facial patterns are inserted into the skin mask based on the feature points and a hair mask identifying one or more regions depicting hair of the user is generated. The computing device extracts a hair region depicted in the image of the user based on the hair mask and inserts the hair region on top of the skin mask to generate a face chart.

### CROSS-REFERENCE TO RELATED APPLICATION

This application claims priority to, and the benefit of, U.S. Provisional Patent Application entitled, “Personalized Face Chart Generator,” having Ser. No. 63/381,204, filed on Oct. 27, 2022, which is incorporated by reference in its entirety.

### TECHNICAL FIELD

The present disclosure generally relates to systems and methods for multi-tiered generation of a face chart using, for example, machine-learning techniques.

### SUMMARY

In accordance with one embodiment, a computing device obtains an image depicting an image of a user's face. The computing device identifies one or more regions in the image depicting skin of the user and generates a skin mask. The computing device predicts a skin tone of the user's face depicted in the image and populates the skin mask according to the predicted skin tone. The computing device defines feature points corresponding to facial features on the user's face depicted in the image and extracts pre-defined facial patterns matching facial features depicted in the image. The computing device inserts the extracted pre-defined facial patterns into the skin mask based on the feature points and generates a hair mask identifying one or more regions in the image depicting hair of the user. The computing device extracts a hair region depicted in the image of the user based on the hair mask and inserts the hair region on top of the

Another embodiment is a system that comprises a memory storing instructions and a processor coupled to the memory. The processor is configured by the instructions to obtain an image depicting an image of a user's face. The processor is further configured to identify one or more regions in the image depicting skin of the user and generate a skin mask. The processor is further configured to predict a skin tone of the user's face depicted in the image and populate the skin mask according to the predicted skin tone. The processor is further configured to define feature points corresponding to facial features on the user's face depicted in the image and extract pre-defined facial patterns matching facial features depicted in the image. The processor is further configured to insert the extracted pre-defined facial patterns into the skin mask based on the feature points and generate a hair mask identifying one or more regions in the image depicting hair of the user. The processor is further configured to extract a hair region depicted in the image of the user based on the hair mask and insert the hair region on top of the skin mask to generate a face chart.

Another embodiment is a non-transitory computer-readable storage medium storing instructions to be implemented by a computing device. The computing device comprises a processor, wherein the instructions, when executed by the processor, cause the computing device to obtain an image depicting an image of a user's face. The processor is further configured by the instructions to identify one or more regions in the image depicting skin of the user and generate a skin mask. The processor is further configured by the instructions to predict a skin tone of the user's face depicted in the image and populate the skin mask according to the predicted skin tone. The processor is further configured by the instructions to define feature points corresponding to facial features on the user's face depicted in the image and extract pre-defined facial patterns matching facial features depicted in the image. The processor is further configured to insert the extracted pre-defined facial patterns into the skin mask based on the feature points and generate a hair mask identifying one or more regions in the image depicting hair of the user. The processor is further configured to extract a hair region depicted in the image of the user based on the hair mask and insert the hair region on top of the skin mask to generate a face chart.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to perform multi-tiered generation of a face chart according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for performing multi-tiered generation of a face chart according to various embodiments of the present disclosure.

FIG. 4 illustrates an example user interface provided on a display of the computing device according to various embodiments of the present disclosure.

FIG. 5 illustrates the skin mask module of FIG. 1 identifying one or more regions in the image depicting the user's skin and generating a skin mask according to various embodiments of the present disclosure.

FIG. 6 illustrates the hair mask module of FIG. 1 generating a hair mask that identifies one or more regions in the image depicting the user's hair according to various embodiments of the present disclosure.

FIG. 7 illustrates the skin tone predictor of FIG. 1 predicting a skin tone of the user's face depicted in the image of the user and populating the face chart according to the predicted skin tone according to various embodiments of the present disclosure.

FIG. 8 illustrates the facial features module of FIG. 1 extracting pre-defined facial patterns matching facial features depicted in the image of the user based on feature points and inserting the extracted pre-defined facial patterns into the face chart according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

The present disclosure is directed to systems and methods for multi-tiered generation of face charts that capture characteristics of the individual's facial features that are more accurate in comparison to conventional configurations, thereby facilitating selection and application of the most suitable cosmetic products for the individual. Face charts may be used by makeup artists to design looks using various cosmetics based on the specific characteristics of a user's face. Therefore, a face chart that accurately captures characteristics of a user's face is essential. A description of a system for performing multi-tiered generation of a face chart is described followed by a discussion of the operation of the components within the system.

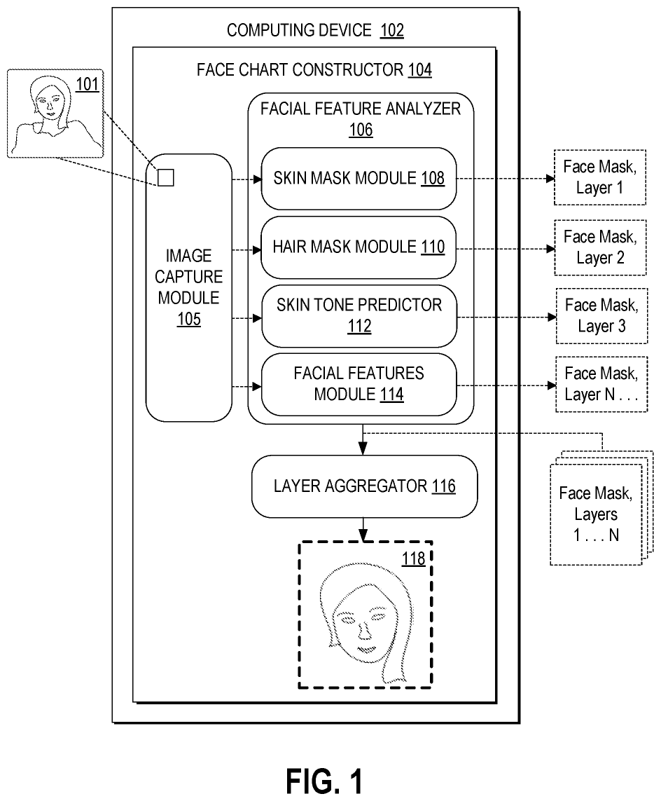

FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A face chart constructor 104 is executed by a processor of the computing device 102 and includes an image capture module 105, a facial feature analyzer 106, and a layer aggregator 116. The facial feature analyzer 106 generates different layers of the face chart where each layer captures characteristics relating to different aspects of the user's face, as described in more detail below. The facial feature analyzer 106 includes a skin mask module 108, a hair mask module 110, a skin tone predictor 112, and a facial features module 114. The layer aggregator 116 is configured to combine all the layers generated by the facial feature analyzer 106 and generate a final face chart 118 of the user.

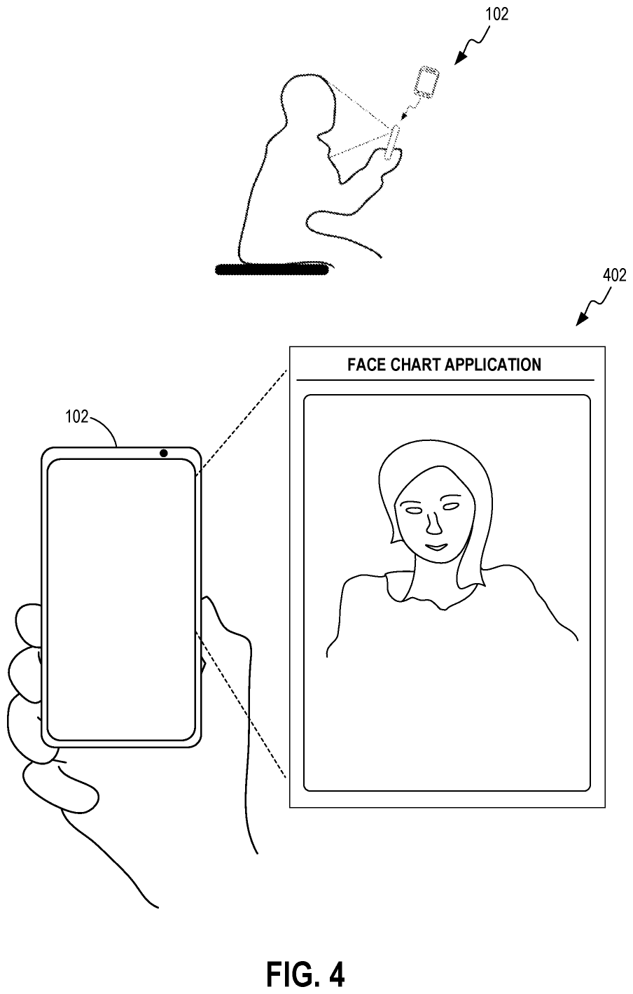

The image capture module 105 is configured to obtain digital images 101 of a user's face. For some embodiments, the image capture module 105 is configured to cause a camera of the computing device 102 to capture an image 101 or a video of the user of the computing device 102. FIG. 4 illustrates an example user interface 402 with a virtual mirror feature generated on a display of the computing device 102 where a digital image of a user is shown in the user interface 402. For some embodiments, the computing device 102 is equipped with a front facing camera that captures an image of the user for multi-tiered generation of a face chart for the user.

Referring back to FIG. 1, the computing device 102 may also be equipped with the capability to connect to the Internet, and the image capture module 105 may be configured to obtain an image or video of the user from another device or server. This feature is used, for example, when the skin mask module 108, the hair mask module 110, and/or the skin tone predictor 112 perform corresponding functions by executing a machine-learning algorithm based on other images of the user.

The images obtained by the image capture module 105 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The video may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

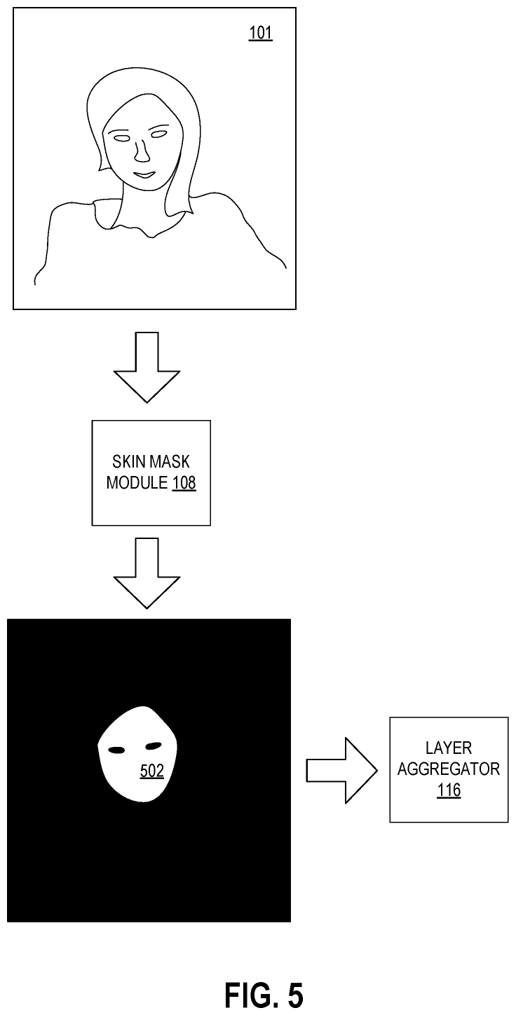

With reference to FIG. 5, the skin mask module 108 executing in the computing device 102 of FIG. 1 is configured to receive the digital image 101 captured by the image capture module 105 (FIG. 1), identify one or more regions in the image 101 depicting the user's skin and generate a skin mask 502 based on the identified regions. The skin mask 502 is used to differentiate between the user's skin, the user's hair, the background of the image, and so on when applying cosmetic effects to the user's face. For some embodiments, the layer aggregator 116 receives the skin mask 502 generated by the skin mask module 108 and generates a first layer of the face chart comprising the skin mask 502.

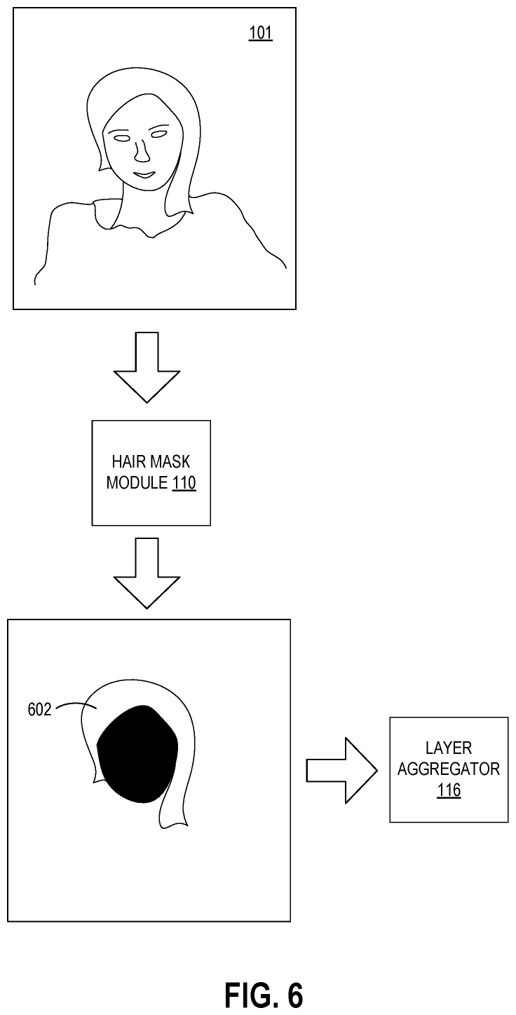

With reference to FIG. 6, the hair mask module 110 executing in the computing device 102 of FIG. 1 is configured to receive the digital image 101 captured by the image capture module 105 (FIG. 1) and generate a hair mask 602 that identifies one or more regions in the image depicting the user's hair. The layer aggregator 116 inserts the generated hair mask 602 as a second layer into the face chart on top of the skin mask generated earlier. For some embodiments, the hair mask module 110 applies a machine-learning algorithm to other images of the user to identify more accurately the one or more regions depicting the user's hair.

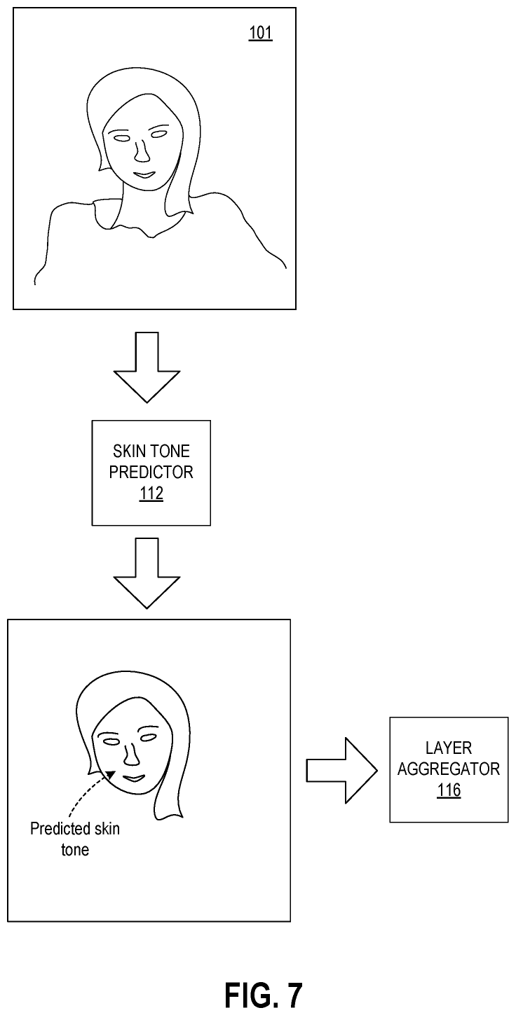

With reference to FIG. 7, the skin tone predictor 112 executing in the computing device 102 of FIG. 1 is configured to receive the digital image 101 captured by the image capture module 105 (FIG. 1) and predict a skin tone of the user's face depicted in the image of the user. The skin tone predictor 112 then populates the face chart according to the predicted skin tone. For some embodiments, the skin tone predictor 112 applies a machine-learning algorithm to other images of the user as well as to images of other individuals to obtain a more accurate prediction of the user's skin tone.

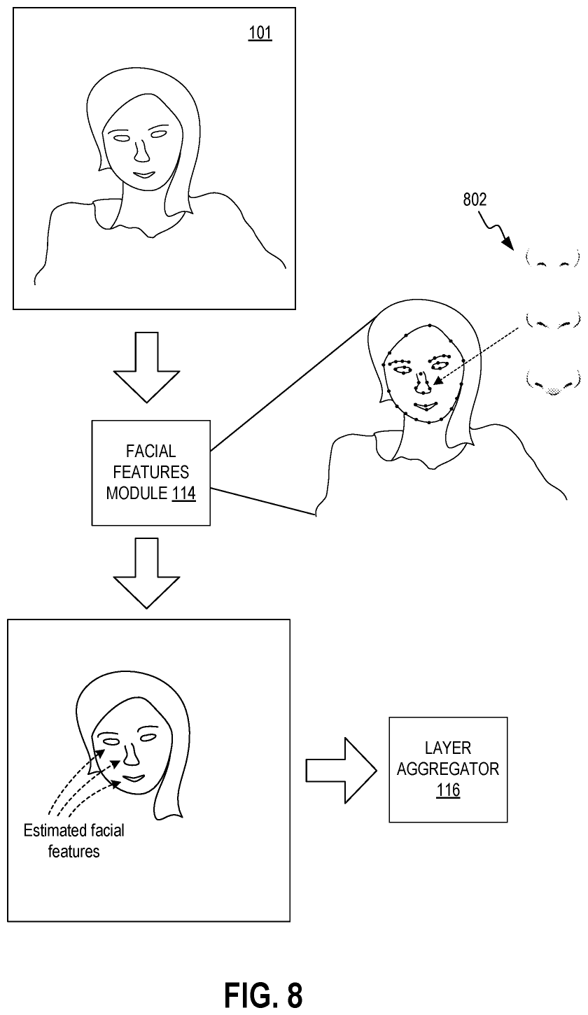

With reference to FIG. 8, the facial features module 114 executing in the computing device 102 of FIG. 1 is configured to receive the digital image 101 captured by the image capture module 105 (FIG. 1) and extract pre-defined facial patterns matching facial features depicted in the image 101 of the user's face based on the feature points. The facial features module 114 inserts the extracted pre-defined facial patterns into the face chart based on the feature points.

In the example shown in FIG. 8, pre-defined nose types 802 are compared to the features points of the user's nose depicted in the image 101. The pre-defined nose type 802 that most closely matches the user's nose is then inserted in the face chart as an estimated nose feature. As another example, pre-defined eye types are compared to the features points of the user's eye depicted in the image 101. The pre-defined eye type that most closely matches the user's eye is then inserted in the face chart as an estimated eye feature. As yet another example, pre-defined mouth types are compared to the features points of the user's mouth depicted in the image 101. The pre-defined mouth type that most closely matches the user's mouth is then inserted in the face chart as an estimated mouth feature.

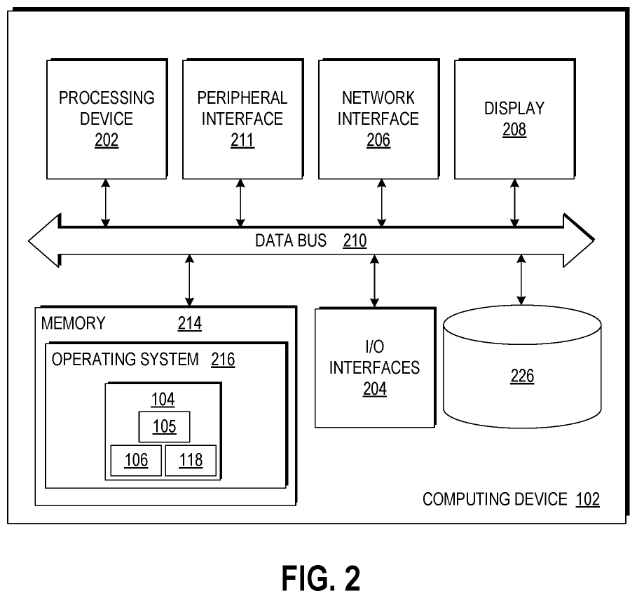

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

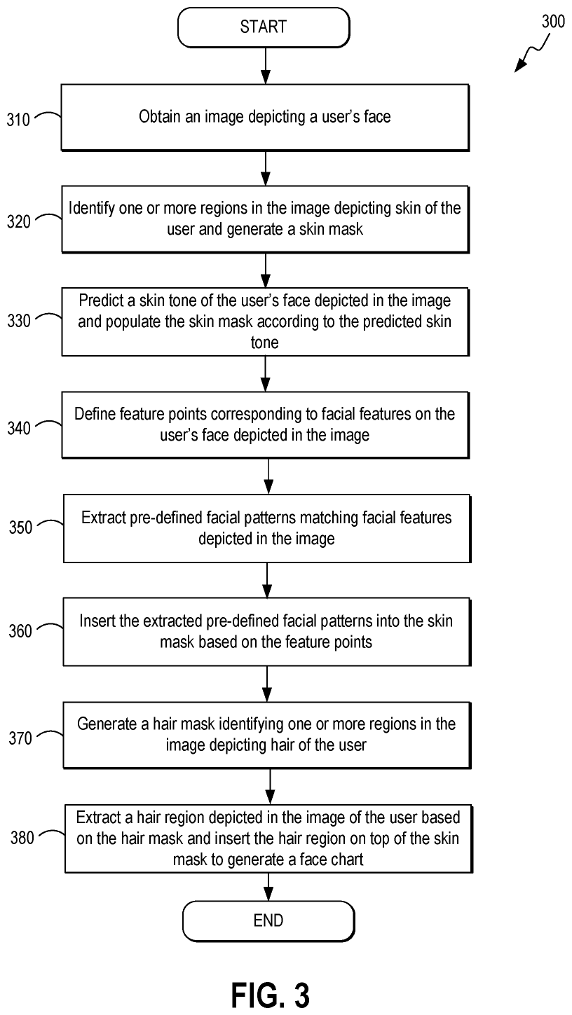

Reference is made to FIG. 3, which is a flowchart 300 in accordance with various embodiments for performing multi-tiered generation of a face chart, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 obtains an image depicting an image of a user's face. At block 320, the computing device 102 identifies one or more regions in the image depicting skin of the user and generates a skin mask. For some embodiments, the computing device 102 identifies the one or more regions in the image depicting the user's skin and generates the skin mask by executing a machine-learning algorithm based on other images of the user.

At block 330, the computing device 102 predicts a skin tone of the user's face depicted in the image and populates the skin mask according to the predicted skin tone. For some embodiments, the computing device 102 predicts the skin tone of the user's face depicted in the image of the user by executing a machine-learning algorithm based on other images of the user and other individuals.

At block 340, the computing device 102 defines feature points corresponding to facial features on the user's face depicted in the image. For some embodiments, the computing device 102 defines the feature points corresponding to the facial features on the user's face depicted in the image is performed by utilizing a convolutional neural network.

At block 350, the computing device 102 extracts pre-defined facial patterns matching facial features depicted in the image. For some embodiments, the pre-defined facial patterns may include, but are not limited to, an eye, a mouth, a nose, or an eyebrow. At block 360, the computing device 102 inserts the extracted pre-defined facial patterns into the skin mask based on the feature points.

At block 370, the computing device 102 generates a hair mask identifying one or more regions in the image depicting hair of the user. For some embodiments, the computing device 102 generates the hair mask identifying the one or more regions in the image depicting the user's hair by executing a machine-learning algorithm based on other images of the user.

At block 380, the computing device 102 extracts a hair region depicted in the image of the user based on the hair mask and inserts the hair region on top of the skin mask to generate a face chart. For some embodiments, the computing device 102 inserts the hair region on top of the skin mask to generate the face chart by extracting the hair region depicted in the image of the user and inserting the extracted hair region on top of the skin mask. As an alternative, the computing device 102 inserts the hair region on top of the skin mask to generate the face chart by inserting a sketch drawing of the user's hair on top of the skin mask. For some embodiments, the computing device 102 generates the face chart by inserting a background into the face chart or superimposing the skin mask on the background. For some embodiments, the background is extracted from the image of the user's face. Thereafter, the process in FIG. 3 ends.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are included herein within the scope of this disclosure and protected by the following claims.

At least the following is claimed:

1. A method implemented in a computing device, comprising:
obtaining an image depicting a user's face;
identifying one or more regions in the image depicting skin of the user and generating a skin mask;
predicting a skin tone of the user's face depicted in the image and populating the skin mask according to the predicted skin tone;
defining feature points corresponding to facial features on the user's face depicted in the image;
extracting pre-defined facial patterns matching facial features depicted in the image;
inserting the extracted pre-defined facial patterns into the skin mask based on the feature points;
generating a hair mask identifying one or more regions in the image depicting hair of the user; and
extracting a hair region depicted in the image of the user based on the hair mask and inserting the hair region on top of the skin mask to generate a face chart.

2. The method of claim 1, wherein inserting the hair region on top of the skin mask to generate the face chart comprises one of:
extracting the hair region depicted in the image of the user and inserting the extracted hair region on top of the skin mask; or
inserting a sketch drawing of the user's hair on top of the skin mask.

3. The method of claim 1, wherein identifying the one or more regions in the image depicting the user's skin and generating the skin mask is performed by executing a machine-learning algorithm based on other images of the user.

4. The method of claim 1, wherein generating the hair mask identifying the one or more regions in the image depicting the user's hair is performed by executing a machine-learning algorithm based on other images of the user.

5. The method of claim 1, wherein predicting the skin tone of the user's face depicted in the image of the user is performed by executing a machine-learning algorithm based on other images of the user and other individuals.

6. The method of claim 1, wherein defining the feature points corresponding to the facial features on the user's face depicted in the image is performed by utilizing a convolutional neural network.

7. The method of claim 1, wherein generating the face chart comprises one of:
inserting a background into the face chart; or
superimposing the skin mask on the background.

8. The method of claim 7, wherein the background is extracted from the image of the user's face.

9. The method of claim 1, wherein the pre-defined facial patterns comprise one of: an eye, a mouth, a nose, or an eyebrow.

10. A system, comprising:
a memory storing instructions;
a processor coupled to the memory and configured by the instructions to at least:
obtain an image depicting a user's face;
identify one or more regions in the image depicting skin of the user and generate a skin mask;
predict a skin tone of the user's face depicted in the image and populate the skin mask according to the predicted skin tone;
define feature points corresponding to facial features on the user's face depicted in the image;
extract pre-defined facial patterns matching facial features depicted in the image;
insert the extracted pre-defined facial patterns into the skin mask based on the feature points;
generate a hair mask identifying one or more regions in the image depicting hair of the user; and
extract a hair region depicted in the image of the user based on the hair mask and insert the hair region on top of the skin mask to generate a face chart.

11. The system of claim 10, wherein the processor is configured to insert the hair region on top of the skin mask to generate the face chart by performing one of:
extracting the hair region depicted in the image of the user and inserting the extracted hair region on top of the skin mask; or
inserting a sketch drawing of the user's hair on top of the skin mask.

12. The system of claim 10, wherein the processor is configured to identify the one or more regions in the image depicting the user's skin and generate the skin mask by executing a machine-learning algorithm based on other images of the user.

13. The system of claim 10, wherein the processor is configured to generate the hair mask identifying the one or more regions in the image depicting the user's hair by executing a machine-learning algorithm based on other images of the user.

14. The system of claim 10, wherein the processor is configured to predict the skin tone of the user's face depicted in the image of the user by executing a machine-learning algorithm based on other images of the user and other individuals.

15. The system of claim 10, wherein the processor is configured to define the feature points corresponding to the facial features on the user's face depicted in the image by utilizing a convolutional neural network.

16. A non-transitory computer-readable storage medium storing instructions to be implemented by a computing device having a processor, wherein the instructions, when executed by the processor, cause the computing device to at least:
obtain an image depicting a user's face;
identify one or more regions in the image depicting skin of the user and generate a skin mask;
predict a skin tone of the user's face depicted in the image and populate the skin mask according to the predicted skin tone;
define feature points corresponding to facial features on the user's face depicted in the image;
extract pre-defined facial patterns matching facial features depicted in the image;
insert the extracted pre-defined facial patterns into the skin mask based on the feature points;
generate a hair mask identifying one or more regions in the image depicting hair of the user; and
extract a hair region depicted in the image of the user based on the hair mask and insert the hair region on top of the skin mask to generate a face chart.

17. The non-transitory computer-readable storage medium of claim 16, wherein the processor is configured by the instructions to insert the hair region on top of the skin mask to generate the face chart by performing one of:
extracting the hair region depicted in the image of the user and inserting the extracted hair region on top of the skin mask; or
inserting a sketch drawing of the user's hair on top of the skin mask.

18. The non-transitory computer-readable storage medium of claim 16, wherein the processor is configured by the instructions to identify the one or more regions in the image depicting the user's skin and generate the skin mask by executing a machine-learning algorithm based on other images of the user.

19. The non-transitory computer-readable storage medium of claim 16, wherein the processor is configured by the instructions to generate the hair mask identifying the one or more regions in the image depicting the user's hair by executing a machine-learning algorithm based on other images of the user.

20. The non-transitory computer-readable storage medium of claim 16, wherein the processor is configured by the instructions to predict the skin tone of the user's face depicted in the image of the user by executing a machine-learning algorithm based on other images of the user and other individuals.
